(19) United States
(12) Patent Application Publication
(10) Pub. No.: US 2023/0002259 A1
(43) Pub. Date: Jan. 5, 2023

(54) TABLETS, METHODS AND DEVICES FOR TREATING CONTAMINATED WATER

(71) Applicant: 121352 CANADA INC. (TECHNOSUB), ROUYN-NORANDA (CA)

(72) Inventors: Abderrazak BERRAK, Sherbrooke (CA); Abdelaziz BOUREGA, Sherbrooke (CA); Mathieu PARÉ, Oka (CA); Patrick MARTEL, Rouyn-Noranda (CA)

(73) Assignee: 121352 CANADA INC. (TECHNOSUB), ROUYN-NORANDA, QC (CA)

(21) Appl. No.: 17/618,497

(22) PCT Filed: Jun. 11, 2020
(86) PCT No.: PCT/CA2020/050798

§ 371 Date: Sep. 2, 2022

(30) Foreign Application Priority Data
Jun. 13, 2019 (CA) 3046577

(51) Int. Cl. C02F 1/52; C02F 1/56

(52) U.S. Cl. CPC C02F 1/5254; C02F 1/56; C02F 2101/16

(57) ABSTRACT

The present disclosure relates to a solid and hydrolyzable tablet for treating contaminated water. The tablet comprises at least one an active ingredient chosen from a precipitating agent, alone or in combination with an agglomerating agent. The disclosure also relates to the use of a tablet for treating contaminated water. The disclosure also relates to a method and a device for treating contaminated water. The method comprises placing water laden with contaminant in contact with a precipitating agent and/or an agglomerating agent, dissolving these agents, mixing these dissolved agents with the water laden with contaminant so as to precipitate and/or agglomerate the contaminant, then separating said contaminant so as to obtain treated water.

### REFERENCE TO RELATED PATENT APPLICATIONS

The present application claims the priority of Canadian application no. 3,046,577 filed on Jun. 13, 2019. This application is incorporated by reference in its entirety.

### FIELD OF THE DISCLOSURE

The present application generally refers to the treatment of contaminated water, and more particularly to the dosage by dissolution of hydrolyzable tablets for the treatment of contaminated water using ammoniacal nitrogen, arsenic, phosphorus and chlorides.

### BACKGROUND OF THE INVENTION

The contamination of a tributary may be due to the presence of ammoniacal nitrogen, arsenic, chlorides and/or phosphorus. Contaminants contained in the water to be treated may be reduced in various ways.

In the tributary to be treated, ammoniacal nitrogen is found in NH₄⁺ (aqueous) and NH₃ (gaseous) forms; these forms are in thermodynamic equilibrium and the predominance of one relative to the other depends closely on the pH. Several technologies exist to eliminate ammoniacal nitrogen, inter alia “stripping,” which consists in favoring the gaseous form of ammoniacal nitrogen and releasing it; biological treatment, which requires a temperature between 25 and 30° C.; oxidation of the ammoniacal nitrogen into nitrates (NO₃⁻), a nitrogen species that can lead to the eutrophication of water areas; and chemical treatment, which is faster, but which also leads to nitrates (NO₃⁻).

Ionized ammoniacal nitrogen can also be reduced chemically. Thus, ionized ammoniacal nitrogen can be precipitated in the form of magnesium ammonium phosphate (MAP) complex to eliminate both the phosphate in its ortho-phosphate form and the nitrogen in its ionized ammoniacal form in the water to be treated. This solution nevertheless requires certain conditions, inter alia respect for the stoichiometry, a molar ratio Mg/P close to 0.9 and a precipitation pH close to 9.

Several methods for simultaneous precipitation of ammoniacal nitrogen and ortho-phosphate already exist, such as the solid-liquid fluidized bed methods or stirred tank methods. For example, international publication no. WO 01/19735 relates to a device and method for treating manure; international publication no. WO 95/05347 relates to an electrolytic system with a series of electrodes for treating manure; international publication no. WO 2007/009749 relates to a reactor and a method for producing MAP from manure or from exhaust containing ammonium and using magnesium; and international publication no. WO 2009/102142 relates to a treatment device combined into two steps, or treatment in an anaerobic reactor followed by a second step for MAP formation.

The simultaneous precipitation of ionized ammoniacal nitrogen and ortho-phosphate can be done with magnesium addition to produce the magnesium ammonium phosphate (MAP) complex.

The precipitation of the ionized nitrogen in the absence of ortho-phosphate may be done with the addition of ortho-phosphate and magnesium to produce the magnesium ammonium phosphate (MAP) complex and/or any other precipitate capable of forming, such as ammonium carbonate with formula (NH₄)₂CO₃, ammonium acetate with formula CH₃COONH₄, ammonium oxalate with formula (NH₄)₂C₂O₄, ammonium sulfate with formula (NH₄)₂SO₄ and/or forms salmiac, an ammonium chloride.

Arsenic reduction has been subject to many studies, and the treatment methods used can be classified into several categories including selective adsorption methods, precipitation and co-precipitation methods, membrane methods and biological methods. The lower elimination efficiency of the As(III) relative to the As(V) requires a prior oxidation step. The precipitation of the arsenic can be done by adding ferric salts, aluminum salts, calcium salts and/or magnesium salts into the water followed by flocculation (polymer) and solid/liquid separation. The obtained precipitate is either ferric, aluminum, calcium and/or magnesium arsenate.

Several methods for reducing the phosphorus in the water exist, such as advanced decanting, aerated biological filters, filters, activated sludges, sequencing batch reactors (SBR), membrane reactors (MBR) and electrocoagulation. The precipitation of the phosphorus can be done by adding ferric salts, aluminum salts, calcium salts and/or magnesium salts into the water followed by flocculation (polymer) and solid/liquid separation. The obtained precipitate is either ferric, aluminum, calcium and/or magnesium phosphate.

Chloride reduction can be done either by adsorption on activated carbon, on natural zeolites, or on ferric oxide, by reverse osmosis, by electrocoagulation, by ion exchange or by chemical treatment. Inter alia, by transformation into hypochlorite ions by oxidation and the latter are treated using ascorbic acid and/or meta-bisulfite. Chloride reduction can also be done by precipitation in the form of an apatite variant with chemical formula Ca₁₀(PO₄)₆Cl₂.

Moreover, several works have studied the influence of physicochemical parameters of the environment (pH, temperature, stirring, etc.) on the nucleation and growth of crystals of the magnesium ammonium phosphate complex, but very few have examined the role of the organic matter present in the environment. However, recent studies, conducted in the medical field to understand the formation of kidney stones, have shown the importance of the composition of the organic fraction on the formation of the crystals of the magnesium ammonium phosphate (MAP) complex.

Many of the cited methods have been faced with major technical and economic constraints making their in situ application difficult and restrictive, and above all, ineffective, as a sole process.

It is therefore desirable to obtain simple and inexpensive methods and processes for separating contaminants in wastewater, such as mining water, while obtaining effective contaminant reduction.

### SUMMARY OF THE DISCLOSURE

In one aspect, the invention relates to the use of a tablet for treating water laden with a contaminant, said tablet comprising a precipitating agent and being solid and hydrolyzable, and wherein said contaminant is ammoniacal nitrogen.

In another aspect, the invention relates to a method for using a tablet for treating water laden with a contaminant, said tablet comprising a precipitating agent and being solid and hydrolyzable, and wherein said contaminant is ammoniacal nitrogen.

In another aspect, the disclosure relates to a tablet comprising at least one precipitating agent alone or in combination with an agglomerating agent, said tablet being in solid and hydrolyzable form.

In another aspect, the disclosure relates to the use of the tablet described herein to treat water laden with a contaminant.

In another aspect, the invention relates to a method for using a tablet described herein, to treat the water laden with a contaminant, wherein the contaminant is chosen from ammoniacal nitrogen, arsenic, phosphorus, chloride and mixtures thereof.

In another aspect, the disclosure relates to a method for manufacturing a tablet for treating water laden with a contaminant, said method comprising:
mixing an active ingredient, chosen from a precipitating agent alone or in combination with an agglomerating agent, and optionally a nonactive ingredient, according to predetermined weights;
homogenizing the mixture;
compressing the mixture to obtain said tablet; and
checking the mass, hardness and/or dissolution speed parameters.

In another aspect, the disclosure relates to a method for treating water laden with a contaminant, said method comprising:
placing the water laden with a contaminant in contact with a precipitating agent alone or in combination with an agglomerating agent;
dissolving the precipitating agent, and optionally the agglomerating agent;
mixing the dissolved precipitating agent, and optionally the dissolved agglomerating agent, and the water laden with contaminant;
precipitating and/or agglomerating said contaminant; and
separating said contaminant in order to obtain treated water.

In another aspect, the disclosure relates to a device for treating water laden with a contaminant, comprising:
at least one pipe through which the water moves and/or at least one reactor in which the water is poured;
at least one tablet containing a precipitating agent alone or in combination with an agglomerating agent to treat said water laden with a contaminant;
at least one perforated support able to contain said at least one tablet and arranged so as to be able to be inserted into said at least one pipe and/or said
at least one reactor, and
at least one mixer and/or at least one stirrer.

In another aspect, the disclosure relates to a kit comprising at least two tablets, a first tablet as defined in the present application and a second tablet as defined in the present application, said first tablet being different from said second tablet.

In another aspect, the disclosure relates to a kit comprising at least two tablets, a first solid and hydrolyzable tablet comprising precipitating agent; and a second solid and hydrolyzable tablet comprising precipitating agent.

In another aspect, the disclosure relates to the use of a kit as defined in the present application to treat water laden with a contaminant.

In another aspect, the disclosure relates to the use of a first solid and hydrolyzable tablet comprising a precipitating agent and a second solid and hydrolyzable tablet comprising a precipitating agent to treat contaminated water.

The present disclosure relates to the development of a method for treating water contaminated with ammoniacal nitrogen, arsenic, phosphorus and chlorides and which comprises placing said contaminated water in contact with solid active ingredients from tablets during the passage of said contaminated water in pipes in various configurations and/or in reactors with stirrers. Said pipes or reactors are supplied with hydrolyzable tablets stacked in perforated supports to continuously deliver/dose the active ingredients necessary to treat the contaminated water in order to precipitate and/or complex said contaminants followed by flocculation and solid-liquid separation. Said hydrolyzable tablets contain a chemical formulation of active ingredients (such as precipitating and agglomerating agents) and optionally nonactive ingredients (for example such as binders and lubricants).

The present disclosure relates to the development of a method using hydrolyzable tablets containing active and nonactive ingredients according to a chemical formulation based on the targeted contamination, or ammoniacal nitrogen, arsenic, phosphorus and chlorides. It will be understood that the dosage and selection of the active and nonactive ingredients will depend on the contaminant and the chemical composition of the water to be treated.

Said tablets are contained in a perforated support through which the contaminated water to be treated passes. The dissolution of the active and nonactive ingredients occurs by dissolution/erosion of the tablet during the passage of the contaminated water.

The present disclosure comprises a chemical formulation to be contained in a hydrolyzable tablet. The chemical formulation is a mixture of active and nonactive water-soluble ingredients and which, when in the presence of the contaminant, such as ammoniacal nitrogen, arsenic, phosphorus and chlorides, cause them to precipitate into a complex that lends itself to a solid-liquid separation.

The present disclosure comprises the dosage by direct and/or indirect dissolution of solid active and nonactive ingredients in the form of hydrolyzable tablets for the treatment of water contaminated with ammoniacal nitrogen, arsenic, phosphorus and chlorides. The method comprises placing hydrolyzable tablets inserted into perforated supports or the like in contact; said perforated supports are installed in a support inserted into the piping (on-line) for passage of the contaminated water and/or in reactors with stirrers. Said tablets release active and nonactive ingredients by dissolution and/or erosion. Said active and nonactive ingredients in contact with the contaminated water react with the ammoniacal nitrogen, arsenic, phosphorus and chlorides to cause them to precipitate in the form of a complex that lends itself to flocculation and solid-liquid separation.

The tablets, methods, devices and uses previously discussed impart several advantages compared to the technological solutions proposed in the prior art. Some of these advantages are listed below. Inter alia: possibility of treatment at the source, low CAPEX OPEX, simple and robust equipment, ease and simplicity of operation, autonomy, flexibility, mobility and portability of equipment, possible reuse of outputs.

### BRIEF DESCRIPTION OF THE FIGURES

The figures of the present disclosure non-limitingly illustrate various examples.

For a better understanding of the different embodiments described here and to more clearly demonstrate how these different embodiments can be carried out, reference will be made, as an example, to the appended drawings, which show at least one example embodiment.

FIG. 1 shows a configuration of a method for treating contaminated water by direct dosage with hydrolyzable tablets made up of a mixture of ingredients 1 (precipitating agent) and 2 (precipitating agent and/or agglomerating agent), according to one embodiment.

FIG. 2 shows a configuration of a method for treating contaminated water by direct dosage in cascading mode with hydrolyzable tablets made up of ingredient 1 (precipitating agent) and hydrolyzable tablets made up of ingredient 2 (precipitating agent and/or agglomerating agent), according to one embodiment.

FIG. 3 shows a configuration of a method for treating contaminated water by direct dosage in parallel mode with hydrolyzable tablets made up of ingredient 1 (precipitating agent) and hydrolyzable tablets made up of ingredient 2 (precipitating agent and/or agglomerating agent), according to one embodiment.

FIG. 4 shows a configuration of a method for treating contaminated water by indirect dosage in parallel mode with hydrolyzable tablets made up of ingredient 1 (precipitating agent) and with hydrolyzable tablets made up of ingredient 2 (precipitating agent and/or agglomerating agent), according to one embodiment. Solution 1 and solution 2 are prepared by (batch) recirculation in the reservoirs before being injected into the pipe of the tributary to be treated.

FIG. 5 shows a configuration of a method for treating contaminated water by indirect dosage in cascading mode with hydrolyzable tablets made up of ingredient 1 (precipitating agent) and hydrolyzable tablets made up of ingredient 2 (precipitating agent and/or agglomerating agent), according to one embodiment. The mixed solution comprising ingredients 1 (precipitating agent) and 2 (precipitating agent and/or agglomerating agent) is prepared by (batch) recirculation before being injected into the pipe of the tributary to be treated.

FIG. 6 shows a view of a cross-section of a reactor used to treat the contaminated water according to a direct dosage method with hydrolyzable tablets made up of ingredient 1 (precipitating agent), according to one embodiment. The reactor is filled with contaminated water and the perforated support containing the tablets is installed inside the reactor. The dissolution of the tablets is controlled by varying the speed of the stirrer installed in the reactor (turbulent or laminar flow). The solution of contaminated water and ingredient 1 (precipitating agent) is prepared by (batch) stirring.

FIG. 7a shows a perspective view illustrating a tablet in capsule form and made up of active and nonactive ingredients, and FIG. 7b is an illustration with a cross-sectional view of a perforated support with capsules arranged inside, according to one embodiment.

FIG. 8 shows a method for treating contaminated water comprising a precipitation phase, a flocculation (agglomeration) phase and a solid-liquid separation phase, according to one embodiment.

FIGS. 9a and 9b show example pipe shapes, according to one embodiment.

FIG. 10 shows a method for treating contaminated water comprising a precipitation phase, a flocculation (agglomeration) phase and a solid-liquid separation phase, with a recirculation option for repetitive treatment operations (in a loop) according to one embodiment.

### DETAILED DESCRIPTION OF THE PRESENT DISCLOSURE

Several embodiments are described in the present application, and are presented solely as an illustration. The described embodiments are in no way meant to be limiting. The present disclosure is applicable to many embodiments, as is obvious from the disclosure described below. The person skilled in the art will recognize that the present disclosure may be put into practice with modifications and changes without departing from the disclosed teachings. Although specific features of the present disclosure may be described in reference to one or several specific embodiments or illustrations, it must be understood that these features are not limited to use in one or several specific embodiments or illustrations in reference to which they are described.

The terms “an embodiment,” “mode,” “embodiments,” “the embodiment,” “the embodiments,” “one or several embodiments” and “certain embodiments” mean “one or several (but not all) embodiments of the present disclosure(s),” unless otherwise expressly specified.

The terms “including,” “comprising” and variants thereof mean “including, but not limited to,” unless otherwise expressly stipulated. A list of elements does not mean that any one or all of the elements are mutually exclusive, unless otherwise expressly stipulated. The terms “a” and “the” mean “one or more,” unless otherwise expressly stipulated.

Furthermore, although the steps of a method may be described (in the disclosure and/or in the claims) in a sequential order, such processes may be configured to work in an alternative order. Furthermore, any sequence or order of steps that may described does not necessarily indicate a requirement that the measures be carried out in that order. The steps of the methods described here may be carried out in any order that is practical. Furthermore, some steps may be carried out simultaneously.

When a single device or object is described here, it will be clear that more than one device/object (whether or not they cooperate) may be used in place of a single device/object. Likewise, when more than one device or object is described here (whether they cooperate or not), it will be obvious that a single device/object can be used in place of the more than one device or object.

It should be noted that the terms of degree such as “substantially,” “about” and “approximately,” when they are used herein, mean a reasonable quantity of deviation of the modified term, such that the final result is not significantly modified. These terms of degree should be interpreted as including a deviation of the modified term if this deviation does not contradict the meaning of the term that it modifies.

Furthermore, the recitation of numerical ranges by endpoints herein comprises all the numbers and fractions encompassed in this range (for example, 1 to 5 comprises 1, 1.5, 2, 2.75, 3, 3.90, 4 and 5). It is also understood that all numbers and fractions thereof are assumed to be modified by the term “about,” which indicates a variation up to a certain quantity of the number to which reference is made if the final result does not change significantly.

Furthermore, the expression “and/or” as used herein indicates an inclusive “or.” In other words, “X and/or Y,” for example, means X or Y or both, and “X, Y and/or Z” means X or Y or Z or any possible combination thereof.

One aspect of the present disclosure relates to the use of a tablet for treating water laden with a contaminant, said tablet comprising a precipitating agent and being solid and hydrolyzable, and wherein said contaminant is ammoniacal nitrogen.

Another aspect of the present disclosure relates to a tablet comprising at least one precipitating agent, said tablet being solid and hydrolyzable.

Another aspect of the present disclosure relates to a tablet comprising at least one active ingredient chosen from a precipitating agent, and furthermore an agglomerating agent, said tablet being solid and hydrolyzable.

It is understood that the choice of the active ingredients (such as the precipitating and agglomerating agents) and nonactive ingredients (such as the binders and the lubricants, the disintegrating agents) and the compression force determine the speed of dissolution and/or erosion of the tablet in the contaminated water.

It is understood that the dissolution of the tablet is determined by its composition in active ingredients (such as the precipitating and agglomerating agents) and the choice of the nonactive ingredients (such as the binders, the lubricants), by the compression force and by the obtained hardness.

It is understood that the dosage of the active and nonactive ingredients is done by controlled dissolution and/or erosion during the passage of the contaminated water. The control of the dosage is related to the hardness of the tablet, the nature of the contaminated water, the active and nonactive ingredients and the hydraulic turbulence (turbulent flow).

It is also understood that the dosage of the active ingredients contained in the tablet is determined by the dissolution time of the tablet, the quantity of tablets placed in contact with the contaminated water, the turbulence and the conditions of the environment (for example temperature, pH, matter in suspension).

The term “tablet” refers to a hydrolyzable solid with a base of a chemical formulation that comprises at least one active ingredient, either a combination of ingredient 1 (precipitating agent) and ingredient 2 (precipitating agent and/or agglomerating agent), or ingredient 1 alone, or ingredient 2 alone. The tablet is produced for example by mixing the active ingredients in solid form and the nonactive ingredients, respecting the weights of the formulation. The obtained mixture is compressed to obtain the tablet in several forms, for example capsule, tablet, agglomerate, pellet, cake, disc, spherical cube, including irregular shapes.

The term “active ingredient” refers to a compound involved in reactions for treating contaminated water, for example a precipitating agent or an agglomerating agent.

The term “nonactive ingredient” refers to a compound used to form the tablet and to control the dissolution and/or erosion during treatment of the contaminated water, for example a binding agent or a lubricant.

For example, the tablet comprises a precipitating agent chosen from a magnesium salt such as magnesium sulfate, magnesium chloride, magnesium phosphate, magnesium hydroxide, magnesium oxide; and/or an aluminum salt such as aluminum sulfate, aluminum chloride, poly-aluminum-silico-sulfate, poly-aluminum; and/or a ferrous salt or a ferric salt such as ferrous sulfate, ferric sulfate, ferrous chloride, ferric chloride; and/or a calcium salt such as calcium sulfate, calcium chloride, calcium phosphate, calcium hydroxide, calcium oxide; and/or an ortho-phosphate salt; and/or an acetate salt; and/or an oxalate; and/or a sulfate; and/or a carbonate; and/or a natural zeolite; and/or an activated carbon; and/or a sodium salt such as a sodium sulfite; sodium thiosulfate; sodium bisulfite; sodium ascorbate; and/or ascorbic acid; and/or calcium thiosulfate and mixtures thereof.

For example, said precipitating agent is in hydrate form. For example, said precipitating agent is in anhydrous form.

For example, the precipitating tablet intended to reduce ammoniacal nitrogen comprises the sources of two ingredients essential to the formation of the magnesium ammonium phosphate (MAP) complex, or a source generating magnesium ions and a source generating orthophosphate ions.

It is understood that the respect for the stoichiometry is a condition favoring the precipitation reaction of the MAP complex. To this end, the magnesium and orthophosphate ions can be diffused in solution such that the product of the concentrations of the magnesium, orthophosphate and ammonium ions exceeds the solubility product of the complex at all times. For example, a precipitation pH of about 7.5 to 10 of the MAP complex also favors the success of the precipitation reaction.

For example, to reduce ammoniacal nitrogen, ingredient 1 (precipitating agent) can refer to a mixture of organic and/or inorganic magnesium salt, such as organic compounds of magnesium polycarboxyl (source of magnesium) and orthophosphate salt or magnesium phosphate, hydrate or anhydrous (source of orthophosphates), or acetate salts or oxalates or sulfates or carbonates.

For example, to reduce arsenic, ingredient 1 (precipitating agent) may refer to aluminum salts such as sulfates or chlorides, pre-polymerized aluminum salts such as polyaluminum silicosulfate (PASS) or polyaluminum chlorides (PAC), to ferrous or ferric salts (ferrous or ferric sulfates, ferrous or ferric chlorides), to magnesium salts (magnesium sulfates, magnesium chloride, magnesium phosphate, magnesium hydroxide, magnesium oxide), or to calcium salts (calcium sulfate, calcium chloride, calcium phosphate, calcium hydroxide, calcium oxide) or to natural zeolites.

For example, to reduce phosphorus, ingredient 1 (precipitating agent) may refer to aluminum sulfate or aluminum chloride, pre-polymerized aluminum salts such as polyaluminum silicosulfate (PASS) or polyaluminum chlorides (PAC), to ferrous or ferric salts (ferrous or ferric sulfates, ferrous or ferric chlorides), to magnesium salts (magnesium sulfate, magnesium chloride, magnesium phosphate, magnesium hydroxide, magnesium oxide), or to calcium salts (calcium sulfate, calcium chloride, calcium phosphate, calcium hydroxide, calcium oxide).

For example, to reduce chlorides, ingredient 1 (precipitating agent) may refer to activated carbon, or to natural zeolites or to sodium sulfite or sodium thiosulfate or sodium bisulfite or sodium ascorbate or ascorbic acid or calcium thiosulfate.

For example, the precipitates formed can be agglomerated in order to separate them mechanically and reuse them. For example, the tablet further comprising an agglomerating agent chosen among polyelectrolytes (anionic, cationic or amphoteric), polymers (anionic, cationic or amphoteric), polyacrylamide, commercial polymers such as Mudwizard™ Coldnet, 5105-LV, 5125-VAL, 5200-VAL, S200-AL, 5800-VAL, S820, S1000-SAL, TTN, ATN, AC1125, AC1200, T1000 and SRH100 and/or an aluminum salt (such as aluminum sulfate, aluminum chloride), and/or a sodium carbonate, sodium bicarbonate, and/or lime (Ca(OH)₂, CaO), and/or tannin and/or mixtures thereof.

For example, when ingredient 2 is an agglomerating agent, it may refer to polyelectrolytes or anionic, cationic or amphoteric polymer, polyacrylamide and/or aluminum salts (aluminum sulfate, aluminum chloride), sodium carbonate, sodium bicarbonate, lime and/or tannin.

For example, the agglomerating agent is a composition comprising a copolymer comprising polyacrylamide and an inorganic salt, as described in American patent No. U.S. Pat. No. 8,076,391 (see in particular Examples 16 to 20), incorporated by reference in its entirety herein.

For example, the tablet further comprises a nonactive ingredient.

For example, the nonactive ingredient is chosen among a binder, a lubricant and mixtures thereof.

For example, the binder is chosen among cellulosic products, fat, oil such as vegetable oil, cocoa butter, coconut butter, starch, lactose, saccharose, gelatin, gum arabic, glucose, sorbitol and/or mixtures thereof.

For example, the lubricant is chosen among products such as magnesium stearate, aluminum stearate, talc, silica, fat, oil such as vegetable oil, cocoa butter, coconut butter and/or mixtures thereof.

According to one embodiment, the tablet contains one or several precipitating agents, and optionally an agglomerating agent and/or one or several nonactive ingredients. For example, the tablet comprises about 20% to about 100%, about 30% to about 100%, about 40% to about 100%, about 50% to about 100%, about 60% to about 100%, about 70% to about 100%, about 80% to about 100% or 90% to about 100% precipitating agent. For example, the tablet comprises about 1% to about 60%, about 1% to about 50%, about 1% to about 40%, about 1% to about 30%, about 1% to about 20% or about 1% to about 10% agglomerating agent. For example, the tablet contains about 0.1% to about 10%, about 0.1% to about 5%, about 0.1% to about 4%, about 0.1% to about 3% or about 0.1% to about 2% nonactive ingredient.

According to another example, a first tablet comprising a precipitating agent is used and a second tablet comprising an agglomerating agent is used. For example, the content in precipitating agent in the first tablet is from about 20% to about 100%, about 30% to about 100%, about 40% to 100%, about 50% to about 100%, about 60% to about 100%, about 70% to about 100%, about 80% to about 100% or 90% to about 100%, the rest being nonactive ingredient. For example, the content in agglomerating agent in the second tablet is from about 20% to about 100%, about 30% to about 100%, about 40% to 100%, about 50% to about 100%, about 60% to about 100%, about 70% to about 100%, about 80% to about 100% or 90% to about 100%, the rest being nonactive ingredient. For example, the first and/or second tablet contains about 0.1% to about 10%, about 0.1% to about 5%, about 0.1% to about 4%, about 0.1% to about 3% or about 0.1% to about 2% nonactive ingredient.

In another aspect, the disclosure relates to the use of the tablet described in the present application to treat water laden with a contaminant.

For example, the water laden with contaminant is mining water. For example, the water laden with contaminant is wastewater.

For example, the tablet allows the reduction of said contaminant by about 10% to about 100%. For example, the tablet allows the reduction of said contaminant by about 20% to about 100%. For example, the tablet allows the reduction of said contaminant by about 30% to about 100%. For example, the tablet allows the reduction of said contaminant by about 40% to about 100%. For example, the tablet allows the reduction of said contaminant by about 50% to about 100%. For example, the tablet allows the reduction of said contaminant by about 60% to about 100%. For example, the tablet allows the reduction of said contaminant by about 70% to about 100%.

For example, said tablet is compressed at about 100 Kgf/cm² to about 2000 Kgf/cm². For example, said mixture is compressed at about 200 Kgf/cm² to about 2000 Kgf/cm². For example, said mixture is compressed at about 300 Kgf/cm² to about 2000 Kgf/cm². For example, said mixture is compressed at about 400 Kgf/cm² to about 2000 Kgf/cm². For example, said mixture is compressed at about 500 Kgf/cm² to about 2000 Kgf/cm². For example, said mixture is compressed at about 800 Kgf/cm² to about 2000 Kgf/cm². For example, said mixture is compressed at about 1.000 Kgf/cm² to about 2000 Kgf/cm². For example, said mixture is compressed at about 1.500 Kgf/cm² to about 2000 Kgf/cm². Said mixture is homogenized and subjected to mechanical pressure between 100 kg/cm² and 2000 kg/cm² so as to be converted into a tablet with a maximum contact surface.

For example, said tablet weighs about 25 g to about 2000 g. For example, said tablet weighs about 25 g to about 500 g. For example, said tablet weighs about 50 g to about 150 g. For example, said tablet weighs about 100 g to about 150 g. For example, said tablet weighs about 60 g to about 90 g.

For example, the tablet is in capsule form.

For example, the capsule has a diameter from about 2 cm to about 15 cm. For example, the capsule has a diameter from about 5 cm to about 10 cm. For example, the capsule has a diameter from about 6 cm to about 9 cm. For example, the capsule has a diameter from about 7 cm to about 8 cm. For example, the capsule has a height from about 5 cm to about 10 cm. For example, the capsule has a height from about 1 cm to about 5 cm. For example, the capsule has a height from about 2 cm to about 4 cm. For example, the capsule has a height from about 2 cm to about 3 cm.

For example, the tablet contains Mg₃(PO₄)₂ as precipitating agent as well as coconut butter as lubricant/binder.

For example, the tablet further contains, as agglomerating agents, polyacrylamide (for example, polyacrylamide S200-AL Mudwizard™), aluminum sulfate and sodium bicarbonate. For example, the capsule contains about 90% polyacrylamide, 7.5% aluminum sulfate and 2.5% sodium bicarbonate.

For example, the contaminant is chosen from ammoniacal nitrogen, arsenic, phosphorus, chloride and mixtures thereof.

For example, the contaminant is ammoniacal nitrogen.

For example, the ammoniacal nitrogen is in the form of NH4+ (aqueous form) or NH3 (gaseous form).

For example, the contaminant comprises ammoniacal nitrogen; said use makes it possible to precipitate said ammoniacal nitrogen in the form of magnesium ammonium phosphate (MAP) and/or others.

In another aspect, the disclosure relates to a method for manufacturing a tablet for treating water laden with a contaminant, said method comprising:
mixing an active ingredient, chosen from a precipitating agent alone or in combination with an agglomerating agent, and optionally a nonactive ingredient, according to predetermined weights;
homogenizing the mixture;
compressing the mixture to obtain said tablet; and
checking the mass, hardness and/or dissolution speed parameters.

For example, said active ingredient is in solid form. For example, said nonactive ingredient is in solid form.

For example, said nonactive ingredient is in liquid form.

For example, said active ingredient comprises a precipitating agent chosen from magnesium salt such as magnesium sulfate, magnesium chloride, magnesium phosphate, magnesium hydroxide, magnesium oxide; aluminum salt such as aluminum sulfate, aluminum chloride, poly-aluminum-silico-sulfate, poly-aluminum; ferrous salt or ferric salt such as ferrous sulfate, ferric sulfate, ferrous chloride, ferric chloride; calcium salt such as calcium sulfate, calcium chloride, calcium phosphate, calcium hydroxide, calcium oxide; ortho-phosphate salt; acetate salt; oxalate; sulfate; carbonate; natural zeolites; activated carbon; sodium sulfite; sodium thiosulfate; sodium bisulfite; sodium ascorbate; ascorbic acid; calcium thiosulfate and mixtures thereof.

For example, said precipitating agent is in hydrate form. For example, said precipitating agent is in anhydrous form.

For example, said active ingredient comprises an agglomerating agent chosen from polyelectrolyte (anionic, cationic or amphoteric), polymer (anionic, cationic or amphoteric), polyacrylamide, aluminum salt (such as aluminum sulfate, aluminum chloride), sodium carbonate, sodium bicarbonate, lime, tannin and mixtures thereof.

For example, said nonactive ingredient is chosen among a binder, a lubricant, an additive and mixtures thereof.

For example, said binder is chosen among cellulosic products, fat, oil such as vegetable oil, cocoa butter, coconut butter, starch, lactose, saccharose, gelatin, gum arabic, glucose, sorbitol and/or mixtures thereof.

For example, said lubricant is chosen among products such as magnesium stearate, aluminum stearate, talc, silica, fat, oil such as vegetable oil, cocoa butter, coconut butter and/or mixtures thereof.

For example, said method comprises mixing about 90% to about 100% precipitating agent, and optionally about 1% to about 10% agglomerating agent and about 1% to about 10% nonactive ingredients.

For example, said mixture is compressed at a force of about 500 kilogram force (Kgf) to about 50,000 Kgf. For example, said mixture is compressed at a force of about 1,000 Kgf to about 50,000 Kgf. For example, said mixture is compressed at a force of about 2,000 Kgf to about 50,000 Kgf. For example, said mixture is compressed at a force of about 3,000 Kgf to about 50,000 Kgf. For example, said mixture is compressed at a force of about 4,000 Kgf to about 50,000 Kgf. For example, said mixture is compressed at a force of about 5,000 Kgf to about 50,000 Kgf. For example, said mixture is compressed at a force of about 10,00 Kgf to about 5022,000 Kgf. For example, said mixture is compressed at a force of about 15,000 Kgf to about 50,000 Kgf.

For example, said mixture is compressed at about 100 Kgf/cm² to about 2.000 Kgf/cm². For example, said mixture is compressed at about 200 Kgf/cm² to about 2000 Kgf/cm². For example, said mixture is compressed at about 300 Kgf/cm² to about 2000 Kgf/cm². For example, said mixture is compressed at about 400 Kgf/cm² to about 2000 Kgf/cm². For example, said mixture is compressed at about 500 Kgf/cm² to about 2000 Kgf/cm². For example, said mixture is compressed at about 800 Kgf/cm² to about 2000 Kgf/cm². For example, said mixture is compressed at about 1,000 Kgf/cm² to about 2,000 Kgf/cm². For example, said mixture is compressed at about 1.500 Kgf/cm² to about 2000 Kgf/cm².

In another aspect, the disclosure relates to a method for treating water laden with a contaminant, said method comprising:
placing the water laden with a contaminant in contact with a precipitating agent alone or in combination with an agglomerating agent;
dissolving the precipitating agent, and optionally agglomerating agent;
mixing the dissolved precipitating agent, and optionally dissolved agglomerating agent, and the water laden with contaminant;
precipitating and optionally agglomerating said contaminant; and
separating said contaminant in order to obtain treated water.

For example, the water laden with contaminant is mine effluent. For example, the water laden with contaminant is wastewater.

For example, the temperature of the water laden with contaminant is from about −5° C. to about 50° C. For example, the temperature of the water laden with contaminant is from about 5° C. to about 50° C. For example, the temperature of the water laden with contaminant is from about 5° C. to about 30° C. For example, the temperature of the water laden with contaminant is from about 5° C. to about 20° C. For example, the temperature of the water laden with contaminant is from about 10° C. to about 25° C.

For example, the water laden with contaminant is mixed during the precipitation and/or the agglomeration.

For example, the water laden with contaminant and the precipitating agent are mixed by means of a mechanical stirrer or a static mixer.

For example, the contaminant is chosen from ammoniacal nitrogen, arsenic, phosphorus, chloride and mixtures thereof.

For example, the water laden with contaminant is in contact with said precipitating agent.

For example, said precipitating agent is chosen from magnesium salt such as magnesium sulfate, magnesium chloride, magnesium phosphate, magnesium hydroxide, magnesium oxide; aluminum salt such as aluminum sulfate, aluminum chloride, poly-aluminum-silico-sulfate, poly-aluminum; ferrous salt or ferric salt such as ferrous sulfate, ferric sulfate, ferrous chloride, ferric chloride; calcium salt such as calcium sulfate, calcium chloride, calcium phosphate, calcium hydroxide, calcium oxide; ortho-phosphate salt; acetate salt; oxalate; sulfate; carbonate; zeolite such as natural zeolite; activated carbon; sodium sulfite; sodium thiosulfate; sodium bisulfite; sodium ascorbate; ascorbic acid; calcium thiosulfate and mixtures thereof.

For example, said agglomerating agent is chosen from polyelectrolytes (anionic, cationic or amphoteric), and/or an aluminum salt (such as aluminum sulfate, aluminum chloride), and/or a sodium carbonate, and/or lime (Ca(OH)₂, CaO), and/or tannin and/or mixtures thereof.

For example, the water laden with contaminant is in contact with said precipitating agent and optionally said agglomerating agent.

For example, said precipitating agent is formulated in tablet form.

For example, said agglomerating agent is formulated in tablet form.

For example, said precipitating and agglomerating agents are formulated together in combined tablet form.

For example, the water laden with contaminant is in contact with a plurality of said tablets.

For example, the tablets are solid and hydrolyzable.

For example, the water laden with contaminant is in contact with a plurality of said tablets so as to dissolve and/or erode said tablets gradually and continuously and to allow the precipitation and optionally said agglomeration of said contaminant.

For example, the dissolution and/or the dosage of the precipitating agents and optionally the agglomerating agents contained in the tablets is direct.

For example, said tablets are at least partially dissolved and/or eroded so as to obtain a solution comprising said precipitating agent and optionally said agglomerating agent prior to placement in contact with the water laden with contaminant.

For example, the dissolution and/or the dosage of the tablets is indirect.

For example, said dissolution of the tablet(s) is done for a duration of about 8 hours to about 1 month, between about 1 week and about 3 weeks, between about 1 week and about 2 weeks, between about 8 hours and about 1 week.

For example, said method is carried out by direct dosage in cascade mode. For example, said method is carried out by direct dosage in parallel mode.

For example, said method is carried out by indirect dosage in cascade mode. For example, said method is carried out by indirect dosage in parallel mode.

For example, said method is done in continuous mode. For example, said method is done in batch mode.

For example, said method is repeated at least one time, two times, three times or four times.

For example, said precipitation and optionally said agglomeration are done for a duration of about 2 hours to about 48 hours, optionally a duration of about 12 hours to about 36 hours or a duration of about 18 hours to about 30 hours.

For example, the tablets are deposited in a perforated support. For example, the tablets are deposited in said perforated support by means of an opening located above said perforated support.

For example, said perforated support is deposited in a reactor in which the water laden with contaminant is poured. For example, said perforated support is deposited in a pipe where the water laden with contaminant circulates.

For example, the perforated support is arranged parallel to the flow of water. For example, the perforated support is arranged perpendicular to the flow of water.

For example, the pipe is U-shaped. For example, the pipe is L-shaped.

For example, the separation is a solid-liquid separation.

For example, the method allows a reduction of said contaminant by about 10% to about 100%. For example, the method allows a reduction of said contaminant by about 20% to about 100%. For example, the method allows a reduction of said contaminant by about 30% to about 100%. For example, the method allows a reduction of said contaminant by about 40% to about 100%. For example, the method allows a reduction of said contaminant by about 50% to about 100%. For example, the method allows a reduction of said contaminant by about 50% to about 90%. For example, the method allows a reduction of said contaminant by about 50% to about 80%. For example, the method allows a reduction of said contaminant by about 50% to about 70%. For example, the method allows a reduction of said contaminant by about 50% to about 60%. For example, the method allows a reduction of said contaminant by about 60% to about 100%. For example, the method allows a reduction of said contaminant by about 60% to about 90%. For example, the method allows a reduction of said contaminant by about 60% to about 80%. For example, the method allows a reduction of said contaminant by about 60% to about 90%. For example, the method allows a reduction of said contaminant by about 60% to about 70%. For example, the method allows a reduction of said contaminant by about 70% to about 100%. For example, the method allows a reduction of said contaminant by about 70% to about 90%. For example, the method allows a reduction of said contaminant by about 70% to about 80%.

In another aspect, the disclosure relates to a device for treating water laden with a contaminant, comprising:
at least one pipe through which the water moves and/or at least one reactor in which the water is poured;
at least one tablet containing a precipitating agent alone or in combination with an agglomerating agent to treat said water laden with a contaminant;
at least one perforated support able to contain said at least one tablet and arranged so as to be able to be inserted into said at least one pipe and/or said at least one reactor, and
at least one mixer and/or at least one stirrer.

For example, said at least one pipe is U-shaped. For example, said at least one pipe is L-shaped.

For example, said device comprising a plurality of tablets comprises a precipitating agent alone or in combination with an agglomerating agent. For example, said device comprises a plurality of tablets comprising a precipitating agent and a plurality of tablets comprising a precipitating agent and/or an agglomerating agent. For example, said device comprising a plurality of tablets comprises a precipitating agent and an agglomerating agent.

For example, the perforated support or the like can be any water-permeable receptacle able to contain said tablets, for example baskets, membranes, pouches, perforated cages or netted bags.

For example, the mixer is a static mixer. For example, the mixer is a mechanical stirrer.

In another aspect, the disclosure relates to a kit comprising at least two tablets, a first tablet as defined in the present application and a second tablet as defined in the present disclosure, said first tablet being different from said second tablet.

In another aspect, the disclosure relates to a kit comprising at least two tablets, a first solid and hydrolyzable tablet comprising precipitating agent; and a second solid and hydrolyzable tablet comprising precipitating agent.

In another aspect, the disclosure relates to the use of a kit as defined in the present application to treat water laden with a contaminant.

For example, said first and/or second tablet comprises about 90% to about 100% precipitating agent, and optionally about 1% to about 10% agglomerating agent and about 1% to about 10% nonactive ingredient.

For example, said first and/or second tablet is compressed at about 100 Kgf/cm² to about 2.000 Kgf/cm². For example, said mixture is compressed at about 200 Kgf/cm² to about 2000 Kgf/cm². For example, said mixture is compressed at about 300 Kgf/cm² to about 2000 Kgf/cm². For example, said mixture is compressed at about 400 Kgf/cm² to about 2000 Kgf/cm². For example, said mixture is compressed at about 500 Kgf/cm² to about 2000 Kgf/cm². For example, said mixture is compressed at about 800 Kgf/cm² to about 2000 Kgf/cm². For example, said mixture is compressed at about 1,000 Kgf/cm² to about 2,000 Kgf/cm². For example, said mixture is compressed at about 1500 Kgf/cm² to about 2000 Kgf/cm².

For example, said first and/or second tablet weighs about 25 g to about 2000 g. For example, said first and/or second tablet weighs about 25 g to about 500 g. For example, said first and/or second tablet weighs about 50 g to about 150 g. For example, said first and/or second tablet weighs about 100 g to about 150 g. For example, said first and/or second tablet weighs about 60 g to about 90 g.

For example, said first and/or second tablet is in capsule form.

For example, the kit further comprises instructions for using said kit to treat contaminated water.

For example, the kit allows the reduction of said contaminant by about 10% to about 100%. For example, the kit allows the reduction of said contaminant by about 20% to about 100%. For example, the kit allows the reduction of said contaminant by about 30% to about 100%. For example, the kit allows the reduction of said contaminant by about 40% to about 100%. For example, the kit allows the reduction of said contaminant by about 50% to about 100%. For example, the kit allows the reduction of said contaminant by about 60% to about 100%. For example, the kit allows the reduction of said contaminant by about 70% to about 100%.

For example, the combined use of said first tablet and said second tablet allows the reduction of said contaminant by about 10% to about 100%. For example, the combined use of said first tablet and said second tablet allows the reduction of said contaminant by about 20% to about 100%. For example, the combined use of said first tablet and said second tablet allows the reduction of said contaminant by about 30% to about 100%. For example, the combined use of said first tablet and said second tablet allows the reduction of said contaminant by about 40% to about 100%. For example, the combined use of said first tablet and said second tablet allows the reduction of said contaminant by about 50% to about 100%. For example, the combined use of said first tablet and said second tablet allows the reduction of said contaminant by about 60% to about 100%. For example, the combined use of said first tablet and said second tablet allows the reduction of said contaminant by about 70% to about 100%.

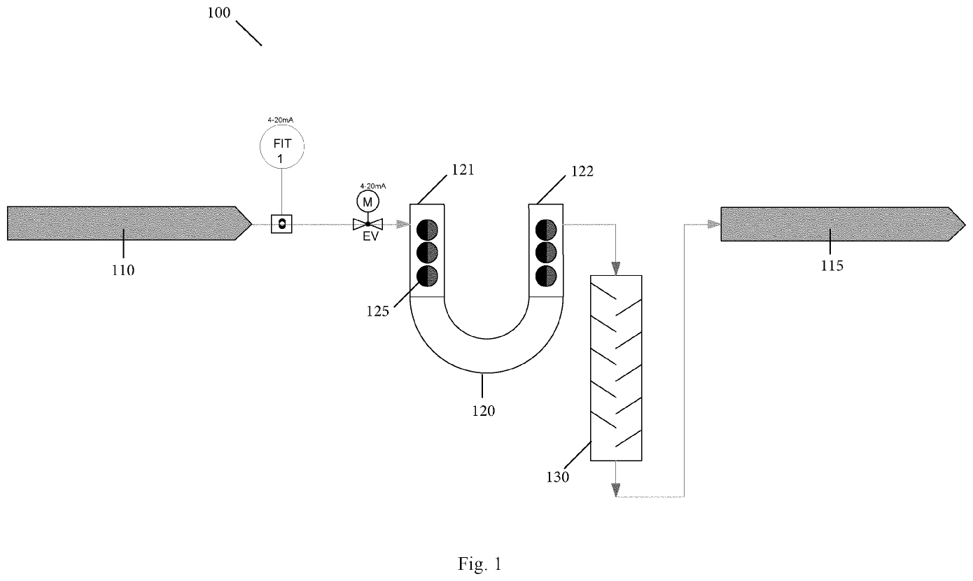

FIG. 1 shows a configuration of a method for treating contaminated water by direct dosage with hydrolyzable tablets containing a mixture of ingredient 1 (precipitating agent) and ingredient 2 (precipitating agent and/or agglomerating agent), according to one embodiment. The method 100 comprises an inlet for water to be treated 110 and an outlet for treated water 115, a U-shaped pipe 120 in which two tablet supports are inserted in the form of perforated supports 121 and 122 containing the hydrolyzable tablets 125, as well as a mixer 130, such as a static mixer for mixing and encouraging the precipitation of contaminant such as for example ammoniacal nitrogen, arsenic, phosphorous, chlorides and mixtures thereof. The method can be done in batch or continuous mode.

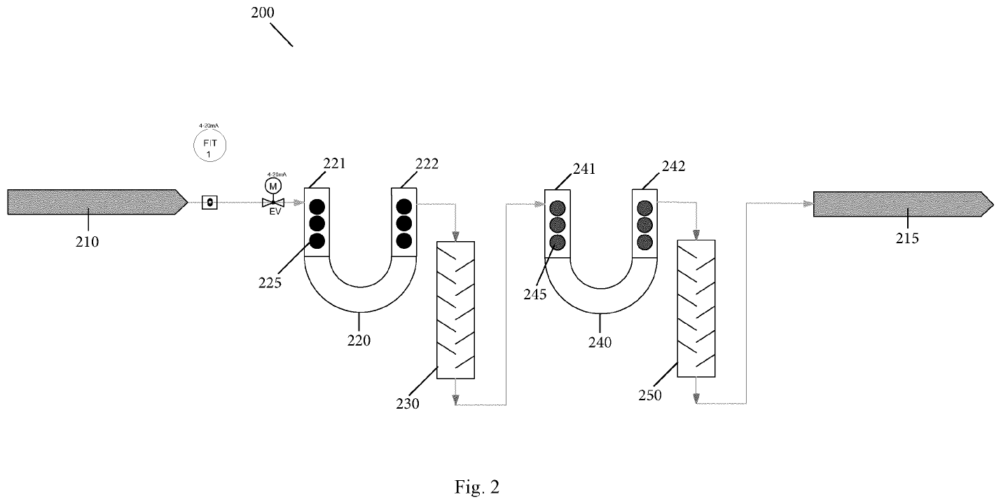

FIG. 2 shows a configuration of a direct dosage method in cascade mode with hydrolyzable tablets containing ingredient 1 and hydrolyzable tablets containing ingredient 2, according to another embodiment. The cascade method 200 comprises an inlet for water to be treated 210 and a treated water outlet 215, two U-shaped pipes 220 and 240 mounted in series and two mixers 230 and 250. In the first U-shaped pipe 220, two tablet supports are inserted in the form of perforated supports 221 and 222 in which the tablets 225 are stacked containing ingredient 1 followed by a mixer 230 and a second U-shaped pipe 240 with two other perforated supports 241 and 242 in which the tablets 245 are inserted containing ingredient 2 followed by a mixer 250.

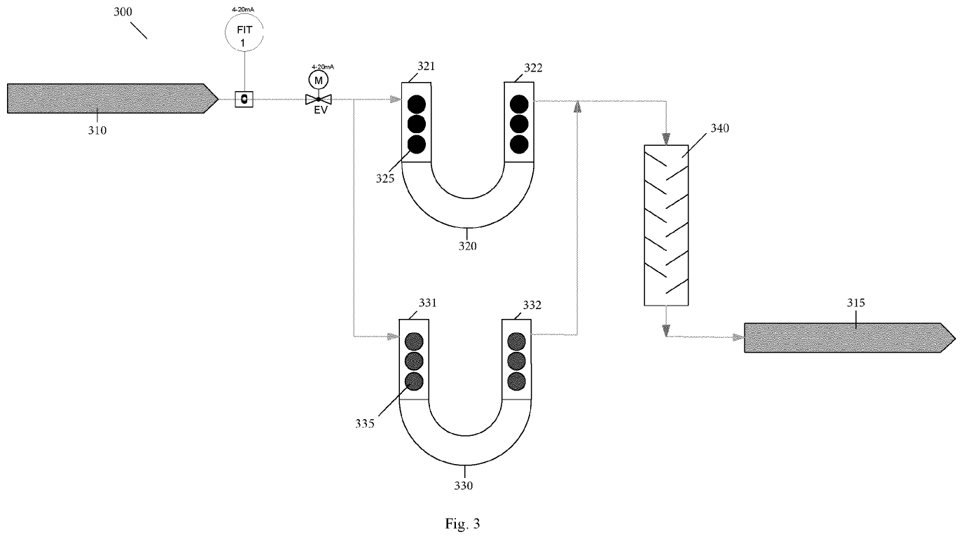

FIG. 3 shows a configuration of a method 300 according to another embodiment for treating contaminated water by direct dosage in parallel mode. The method 300 comprises an inlet for water to be treated 310 and a treated water outlet 315. The method 300 comprises two U-shaped pipes 320 and 330 arranged in parallel. The water to be treated is placed in contact with hydrolyzable tablets 325 containing ingredient 1 in the U-shaped pipe 320 and hydrolyzable tablets 335 containing ingredient 2 in the U-shaped pipe 330. The tablets 325 are inserted into two tablet supports in the form of perforated supports 321 and 322, while the tablets 335 are inserted into two perforated supports 331 and 332. Solution 1 generated from the dissolution of ingredient 1 and solution 2 generated from the dissolution of ingredient 2 are introduced in a same mixer 340.

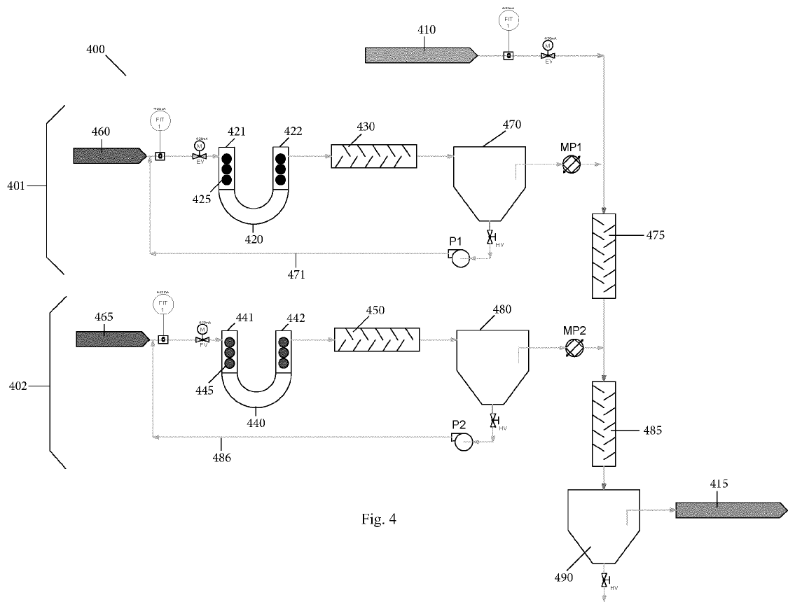

FIG. 4 shows a configuration of an indirect dosage method in parallel mode, according to another embodiment. The method 400 comprises a circuit 1 401 and a circuit 2 402 arranged in parallel mode. Each of the circuits 1 and 2 comprises a water inlet 460 and 465, respectively. The water coming from the inlet 460 passes through a U-shaped pipe 420 and is placed in contact with hydrolyzable tablets 425 containing ingredient 1 so as to dissolve or erode the tablets 425. The tablets 425 are arranged in tablet supports in the form of perforated supports 421 and 422 inserted into the pipe 420. Following a passage in a mixer 430, solution 1 is produced, then stored in a reservoir 470. Solution 1 is recirculated 471 with the tablets 425. Similarly, the water coming from the inlet 465 passes through a U-shaped pipe 440 and is placed in contact with hydrolyzable tablets 445 containing ingredient 2 so as to dissolve or erode the tablets 445. The tablets 445 are arranged in perforated supports 441 and 442 inserted into the pipe 440. Following a passage in a mixer 450, solution 2 is produced, then stored in a reservoir 480. Solution 2 is recirculated 486 with the tablets 445. Solutions 1 and 2 stored in reservoirs 1 470 and reservoir 2 480, respectively, are injected through metering pumps into the contaminated water pipe. The tributary to be treated 410 is thus placed in contact with solution 1, then passes through a mixer 475. The tributary mixed with solution 1 is next placed in contact with solution 2, then passes through a mixer 485. The treated water is stored in the reservoir 490, where a water outlet 415 is included.

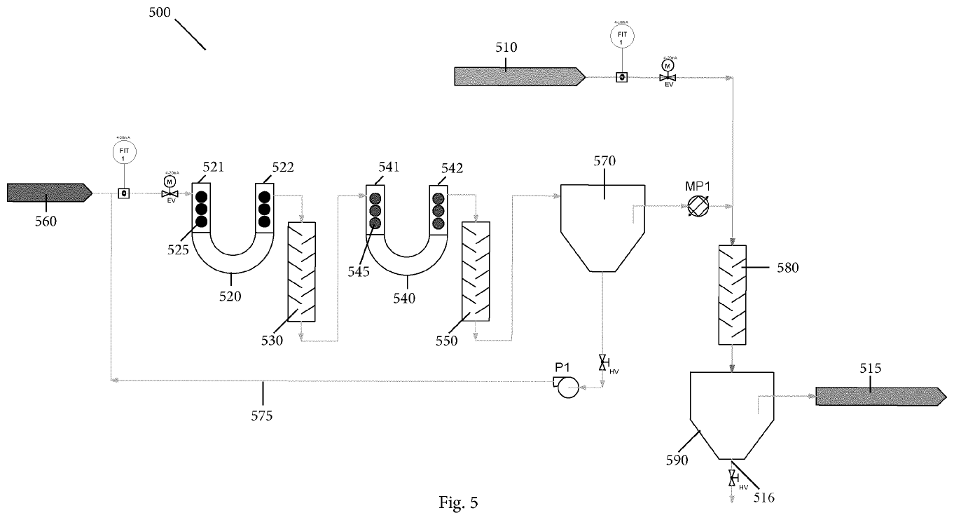

FIG. 5 shows a configuration of an indirect dosage method in cascade mode, according to another embodiment. This cascade method 500 comprises an inlet for water to be treated 510 and a treated water outlet 515, another water inlet 560, two U-shaped pipes 520 and 540 mounted in series and two mixers 530 and 550. The water coming from the inlet 560 passes through a first U-shaped pipe 520, where it is placed in contact with hydrolyzable tablets 525 containing ingredient 1. Following a passage in a mixer 530, the water next passes through a second U-shaped pipe 540, where it is placed in contact with hydrolyzable tablets 545 containing ingredient 2. Following a passage in another mixer 550, the solution produced is poured into a storage reservoir 570. In the first U-shaped pipe 520, two tablet supports are inserted in the form of perforated supports 521 and 522 in which the tablets 525 are stacked; and in the second U-shaped pipe 540, two other perforated supports 541 and 542 are inserted, in which the tablets 545 are inserted. As mentioned, the solution generated by dissolving ingredients 1 and 2 is poured into a reservoir 570 provided with two outlets, one intended for recirculating 575 the solution and the second for dosing the solution by means of a pump in the pipe for contaminated water. Thus, the mixed solution obtained by recirculating 575 the mixture of ingredient 1 and ingredient 2 is injected into the pipe for the tributary to be treated 510. The water to be treated and the mixed solution are mixed in a mixer 580. The treated water is poured in the solid-liquid separation reservoir 590, where a water outlet 515 is included and a sludge (precipitate) outlet is included 516. The configuration shown in FIG. 5 allows treatment in continuous or recirculation (batch) mode.

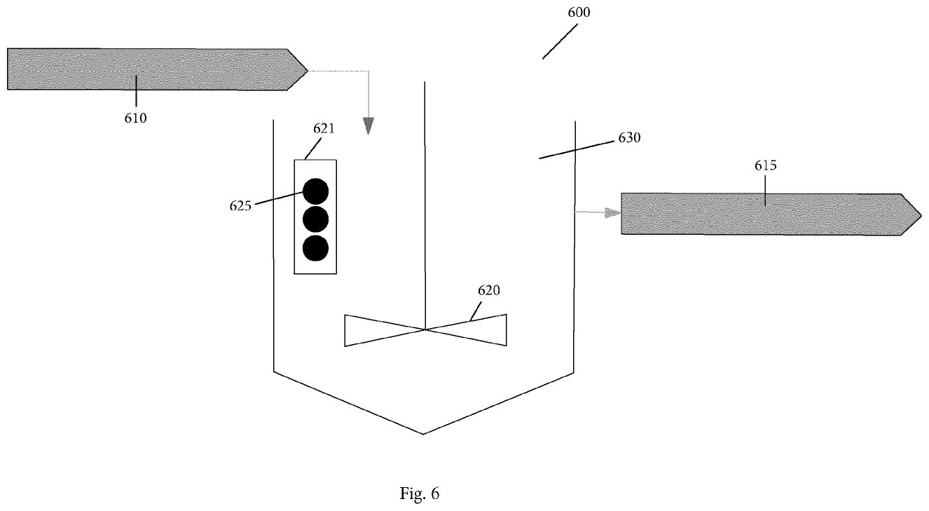

FIG. 6 shows a cross-sectional view of a reactor used to treat the contaminated water according to a direct dosage method 600 with hydrolyzable tablets 625 inserted into a reactor 630 with stirrer 620 (by batch or continuously). Said reactor 620 is filled with contaminated water via an inlet 610 in which a perforated support 621 containing tablets 625 comprising one or more active ingredients is submerged. The dissolution is controlled with the variation of the stirring speed (turbulent, transitional or laminar flow). The treated water is next poured through the outlet 615 of the reactor.

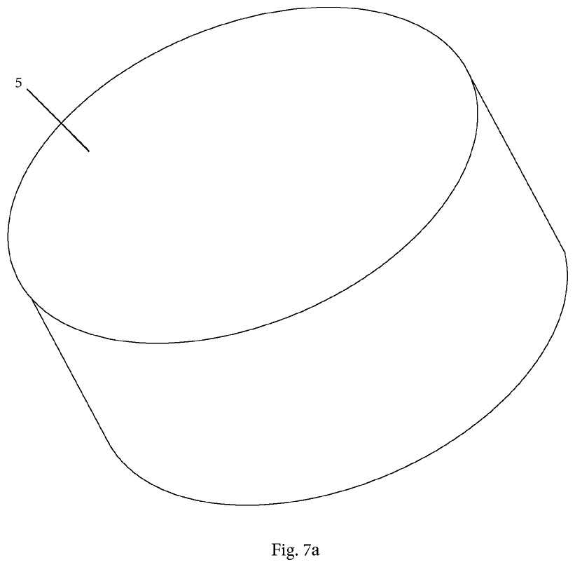

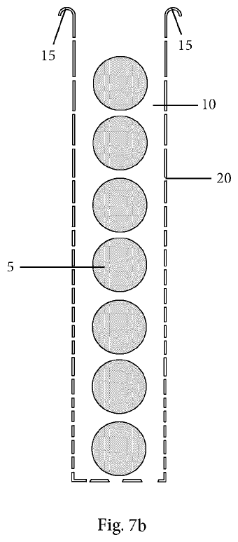

FIG. 7a illustrates a tablet 5 in capsule form made up of active and nonactive ingredients. FIG. 7b shows a perspective view showing the arrangement of the capsules in a perforated support. The perforated support in basket form 10 having a generally cylindrical shape comprises a plurality of capsules 5 inserted inside the basket. For example, the basket 10 may comprise one or several hooks 15 near its opening so as to retain the basket in a pipe or a reactor. The dotted lines 20 illustrate the perforation of the basket. It is understood that perforated supports having other appropriate shapes are also sought after, particularly when used in a method employing a reactor in which the support is submerged. For example, the basket or the like can be any water-permeable receptacle able to contain said tablets, for example membranes, pouches, perforated cages or netted bags. For example, in the context of a pipe, such as a U- or L-shaped pipe, the perforated support can be an integral part of the pipe, that is to say, it can be incorporated into the pipe.

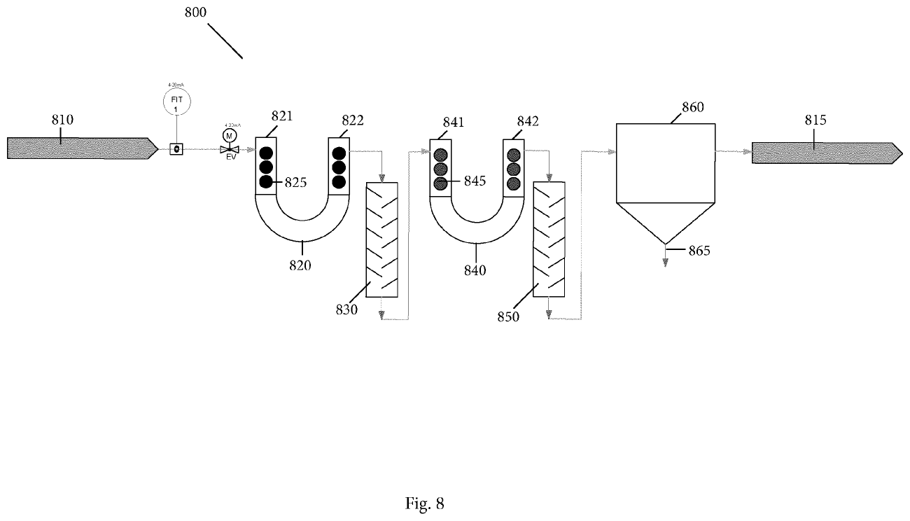

FIG. 8 shows a method for treating contaminated water with a precipitation phase, a flocculation (or agglomeration) phase and a solid-liquid separation phase, according to another embodiment. The treatment can be done in continuous or closed loop mode continuously until the targeted reduction is achieved. More particularly, the method 800 comprises an inlet for water to be treated 810. The water to be treated passes through a first pipe 820, where it is placed in contact with hydrolyzable tablets 825 containing active ingredient 1. Said hydrolyzable tablets 825 are arranged in perforated supports in the form of baskets 821 and 822 that are inserted into the U-shaped pipe 820. Following a passage in a mixer 830 that allows stirring, the water next passes through a second U-shaped pipe 840, where it is placed in contact with hydrolyzable tablets 845 containing the active ingredient 2, or a flocculating agent (polymer). Said hydrolyzable tablets 845 are arranged in perforated supports 841 and 842 that are inserted into the U-shaped pipe 840. Following passage in a mixer 850 that allows stirring, the obtained solution is subject to solid-liquid separation 860 (for example, mechanical separation). The resulting product is treated water for which an outlet 815 is provided. Another outlet 865 is also provided for the solid contaminants. It is understood that any appropriate solid-liquid separation can be used, for example but not limited to filtration, decanting, centrifugation.

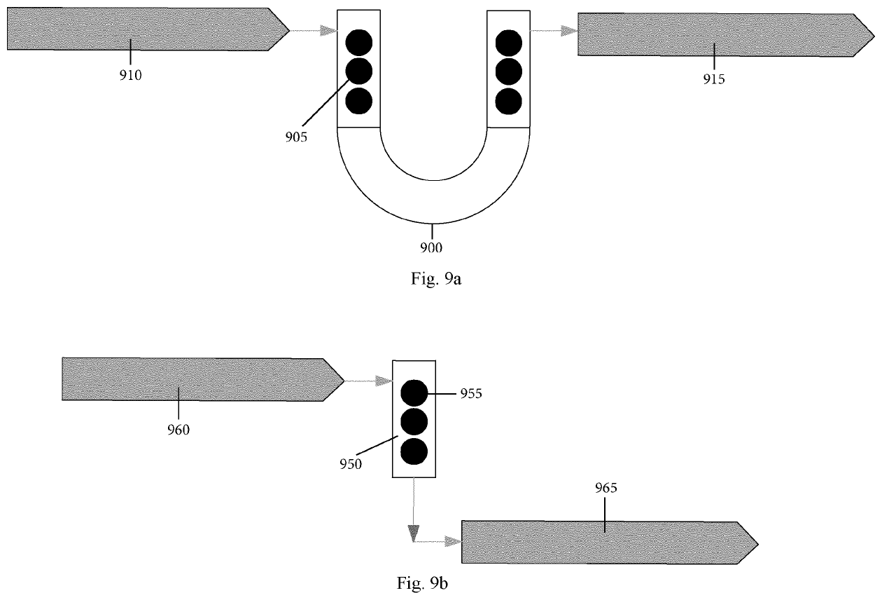

FIG. 9a and FIG. 9b show two example pipe shapes. In another embodiment, the pipe 900 is U-shaped (FIG. 9a) and comprises a water inlet 910 and a water outlet 915. Tablets 905 can be inserted into both ends of the pipe 900. In another embodiment, the pipe 950 is L-shaped (FIG. 9b) and comprises a water inlet 960 and a water outlet 965. Tablets 955 can be inserted through the length of the pipe 950. It is understood that other appropriate pipe shapes are also sought after.

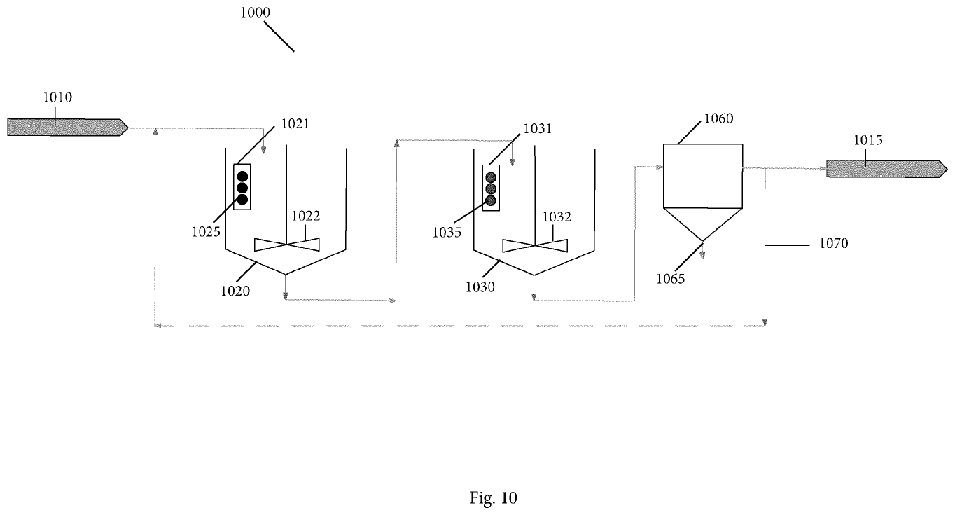

FIG. 10 shows a method for treating contaminated water according to another embodiment. The method 1000 comprises a precipitation phase, a flocculation phase and a solid/liquid separation phase. The treatment can be done in continuous or closed loop mode continuously until the targeted reduction is achieved. The method comprises a recirculation option for repetitive treatment operations. More particularly, the method 1000 comprises an inlet for water to be treated 1010. The water to be treated is poured into a first reactor 1020. Hydrolyzable tablets 1025 containing active ingredient 1 are inserted into the reactor 1020 by means of a perforated support 1021. The dissolution is controlled by varying the stirring speed of the stirrer 1022. Subsequently, the water the be treated having been mixed with the tablets 1025 is poured into a second reactor 1030. Hydrolyzable tablets 1035 containing active ingredient 2, or a flocculating agent (polymer), are inserted into this reactor 1030 by means of a perforated support 1031. The dissolution is controlled by varying the stirring speed of the stirrer 1032. The solution thus obtained is next subject to solid-liquid separation 1060 (for example, mechanical separation). The resulting product is treated water for which an outlet 1015 is provided. Another outlet 1065 is also provided for the solid contaminants. The method also provides a recirculation step 1070 in which the treated water can be retreated, that is to say, subject to treatment steps in the reactors 1020 and 1030 so as to increase the contaminant reduction rate. For example, the water can be retreated once, twice, three times or more than four times. For example, the treatment is repetitive (in a loop).

As described in the examples, the method now described allows a contaminant reduction rate of at least 10%, for example, a reduction rate of about 10% to about 90%, about 20% to about 90, about 30% to about 90%, about 40% to about 90%, about 50% to about 90% or about 60% to about 90%.

The description must be interpreted as an illustration of the present technology, but must not be considered to limit the claims. The scope of the claims must not be limited by the examples, but must be given the broadest interpretation in accordance with the description as a whole.

The examples presented in this disclosure are presented non-limitingly.

### EXAMPLE 1: REDUCTION OF AMMONIACAL NITROGEN

Tests and analyses to determine the percentage of reduction of ammoniacal nitrogen were done with tablets comprising an active ingredient, or a precipitating agent (see Table 1), and with tablets comprising a precipitating agent in combination with tablets comprising an agglomerating agent. The reduction rates were measured with a spectrophotometer. The synthetic water used contained a total ammoniacal nitrogen concentration able to reach about 2,000 ppm.

Other analyses were done with tablets containing one or two active ingredients, or a precipitating agent 1, or two precipitating agents 1 and 2 (see Table 2). The reduction rates were measured with a spectrophotometer. The synthetic water used contained a total ammoniacal nitrogen concentration able to reach about 50 to 150 ppm.

Table 1 shows the results of treatments of synthetic water (solution prepared with water and ammonia) and a mine effluent with tablets containing Mg₃(PO₄)₂ as precipitating agent. More particularly, the tablets were manufactured by compressing the Mg₃(PO₄)₂ in powder form and by adding a very small amount of coconut butter as nonactive ingredient, acting as lubricant/binder. The analysis was done immediately after precipitation/agglomeration. As described below, the percentage of reduction of ammoniacal nitrogen in the mine effluent varies between 60% and 81%.

TABLE 1
SYNTHETIC WATER AND MINE
EFFLUENT TREATMENT RESULTS

| Test number | Tributaries | Precipitating agent | Agglomerating agent | Reduction rate | Notes |
|---|---|---|---|---|---|
| 6.1 | Synthetic | Mg₃(PO₄)₂ | — | 80% | Instantaneous |
| | solution | | | | analysis |
| 6.5 | Synthetic | Mg₃(PO₄)₂ | — | 50% | Instantaneous |
| | solution | | | | analysis |
| 14-1 | Mine | Mg₃(PO₄)₂ | — | 60% | Instantaneous |
| | effluent | | | | analysis |
| 15-5 | Mine | Mg₃(PO₄)₂ | — | 81% | Instantaneous |
| | effluent | | | | analysis |

Table 2 shows the results of treatments of synthetic water (solution prepared with water and ammonia) with tablets containing the precipitating agent. More particularly, the tablets were manufactured by compressing precipitating agents 1 and 2 in solid form and adding the nonactive ingredients. As described below, the percentage of reduction of ammoniacal nitrogen in the mine water varies between 57% and 85%.

TABLE 2
SYNTHETIC WATER TREATMENT RESULTS

| | | | PRECIPITATING AGENTS | REDUCTION |
|---|---|---|---|---|
| TEST # | Contaminant | SAMPLE | (active ingredients) | RATE % |
| LAB190820-2 | AMMONIACAL | SYNTH. | MgH(PO)₄•3H₂O/Na(OH) | 78% |
| | NITROGEN | SOL. | | |
| LAB190828-02-6 | AMMONIACAL | SYNTH. | MgSO₄/Na₂PO₄ | 73% |
| | NITROGEN | SOL. | | |
| LAB190829-01 | AMMONIACAL | SYNTH. | MgSO₄/Na₂PO₄ | 73% |
| | NITROGEN | SOL. | | |
| LAB190904-01-4 | AMMONIACAL | SYNTH. | MgCl₂•6H₂O/Na₂HPO₄ | 71% |
| | NITROGEN | SOL. | | |
| LAB190904-02-2 | AMMONIACAL | SYNTH. | MgCl₂•6H₂O/Na₂HPO₄ | 85% |
| | NITROGEN | SOL. | | |
| LAB2000505-12 | AMMONIACAL | SYNTH. | Na₂HPO₄/C4H₄MgO₅ | 57% |
| | NITROGEN | SOL. | | |

Table 3 shows results of the treatment of mine water with 1) tablets containing Mg₃(PO₄) as precipitating agent (as described above) and 2) tablets containing agglomerating agents. More particularly, the tablets comprising agglomerating agents were manufactured by compressing the following agglomerating agents (in powder form): 90% polyacrylamide (S200-AL Mudwizard™), 7.5% aluminum sulfate and 2.5% sodium bicarbonate. The instantaneous analyses and 24-hour analyses were done after precipitation and agglomeration. As described below, the reduction efficiency 24 hours after the precipitation and agglomeration reactions is increased compared to the instantaneous analysis, or an improvement of 18% and 23% for tests no. 67 and 68, respectively.

TABLE 3
RESULTS OF INSTANTANEOUS AND 24-HOUR ANALYSES

| Test number | Effluents | Precipitating agent | Agglomerating agent | Reduction rate | Notes |
|---|---|---|---|---|---|
| 67 | Mine | Mg₃(PO₄)₂ | Polyacrylamide | 65% | Instantaneous |
| | effluent | | (S200-AL | | analysis |
| | | 143 | Mudwizard ™) | 79% | Analysis after |
| | | | Al₂(SO₄)₃ | | 24 h |
| | | | NaHCO₃ | | |
| 68 | Mine | Mg₃(PO₄)₂ | Polyacrylamide | 55% | Instantaneous |
| | effluent | | (S200-AL | | analysis |
| | | | Mudwizard ™) | 71% | Analysis after |
| | | | AL₂(SO₄)₃• | | 24 h |
| | | | NaHCO₃ | | |

Table 4 shows results of the treatment of water from two mines with tablets containing the mixture of two precipitating agents 1 and 2 with defined proportions. The instantaneous analyses were done after precipitation and solid/liquid separation.

TABLE 4
RESULTS OF MINE EFFLUENT INSTANTANEOUS ANALYSES

| | | | PRECIPITATING- | |
|---|---|---|---|---|
| | | | AGENTS | |
| TEST # | Contaminant | SAMPLE | (active ingredients) | REDUCTION RATE % |
| LAB190909- | AMMONIACAL | Mine effluent | MgO/Na₂HPO₄ | 65% |
| 03 | NITROGEN | 1 | | |
| LAB191002- | AMMONIACAL | Mine effluent | MgO/Na₂HPO₄ | 74% |
| 05 | NITROGEN | 1 | | |
| LAB190906- | AMMONIACAL | Mine effluent | MgCl₂•6H₂O/Na₂HPO₄ | 52% |
| 04 | NITROGEN | 1 | | |
| LAB190909- | AMMONIACAL | Mine effluent | MgO/Na₂HPO₄ | 65% |
| 03 | NITROGEN | 1 | | |
| LAB191001- | AMMONIACAL | Mine effluent | Mg/Na₂HPO₄ Citrate | 74% |
| 01 | NITROGEN | 2 | | |
| LAB190909- | AMMONIACAL | Mine effluent | MgO/Na₂HPO₄ | 15% |
| 04 | NITROGEN | 2 | | |
| LAB191010- | AMMONIACAL | Mine effluent | Mg/Na₂HPO₄ Citrate | 81% |
| 02 | NITROGEN | 2 | | |
| LAB2000507- | AMMONIACAL | Mine effluent | Na₂HPO₄/C₄H₄MgO₅ | 58% |
| 01 | NITROGEN | 2 | | |
| LAB200224- | AMMONIACAL | Mine effluent | Na₂HPO₄/C₆H₆MgO₇ | 54% |
| 03 | NITROGEN | 2 | | |

Table 5 shows results for repetitive treatments (in recirculation) of mine water. More particularly, one can see that the reduction efficiency increases as a function of the number of treatment cycles.

TABLE 5
TREATMENT IN RECIRCULATION, REPETITIVE CYCLES

| Test number | Effluents | Precipitating agent | Agglomerating agent | Reduction rate | Notes |
|---|---|---|---|---|---|
| 72-1 | Mine | Mg₃(PO₄)₂ | Polyacrylamide (S200- | 70% | 1^{st} |
| | effluent | | AL Mudwizard ™) | | treatment |
| | | | Al₂(SO₄)₃ | | |
| | | | NaHCO₃ | | |
| 72-2 | Mine | Mg₃(PO₄)₂ | Polyacrylamide (S200- | 82% | 2^{nd} |
| | effluent | | AL Mudwizard ™) | | treatment |
| | | | Al₂(SO₄)₃ | | |
| | | | NaHCO₃ | | |
| 72-3 | Mine | Mg₃(PO₄)₂ | Polyacrylamide (S200- | 86% | 3^{rd} |
| | effluent | | AL Mudwizard ™) | | treatment |
| | | | Al₂(SO₄)₃ | | |
| | | | NaHCO₃ | | |
| 72-4 | Mine | Mg₃(PO₄)₂ | Polyacrylamide (S200- | 89% | 4^{th} |
| | effluent | | AL Mudwizard ™) | | treatment |
| | | | Al₂(SO₄)₃ | | |
| | | | NaHCO₃ | | |

Table 6 shows the results of ammoniacal nitrogen reduction tests with a control unit done on a mining site according to the method mentioned in FIG. 10. The tests were done with a continuous and turbulent method. The unit was supplied with tablets of precipitating agents as described in this application (see FIG. 7a) stacked in baskets (see FIG. 7b).

TABLE 6
RESULTS OF MINE EFFLUENT INSTANTANEOUS ANALYSES

| | | | PRECIPITATING | |
|---|---|---|---|---|
| | | | AGENTS | |
| TEST # | Contaminant | SAMPLE | (active ingredients) | REDUCTION RATE % |
| ST190122-01 | AMMONIACAL | MINE | Mg/Na₂HPO₄Citrate | 48% |
| | NITROGEN | EFFLUENT | | |

### EXAMPLE 2: ARSENIC REDUCTION

Tests and analyses to determine the percentage of arsenic reduction were done with tablets comprising an active ingredient, or a precipitating agent 1, and nonactive ingredients (see Table 7). The reduction rates were measured with a spectrophotometer.

Table 7 shows results of the treatment of water from two mines with tablets containing the precipitating agent and nonactive ingredients with defined proportions. The instantaneous analyses were done after precipitation and solid/liquid separation.

TABLE 7
RESULTS OF MINE EFFLUENT
INSTANTANEOUS ANALYSES

| | | | PRECIPITATING | |
|---|---|---|---|---|
| | | | AGENTS | |
| TEST # | Contaminant | SAMPLE | (active ingredients) | REDUCTION RATE % |
| LAB191202-01 | ARSENIC | MINE EFFLUENT | FeCl₃ | 99.9% |
| LAB191202-02 | ARSENIC | MINE EFFLUENT | FeCl₃ | 99.9% |
| LAB191202-04 | ARSENIC | MINE EFFLUENT | FeCl₃ | 99.9% |

### EXAMPLE 3: CHLORIDE REDUCTION

Tests and analyses to determine the percentage of chloride reduction were done with tablets comprising two active ingredients, or the combination of two precipitating agents 1 and 2, and nonactive ingredients (see Table 8). The reduction rates were measured with a spectrophotometer.

Table 8 shows results of the treatment of water from two mines with tablets containing comprising two active ingredients, or the combination of two precipitating agents 1 and 2, and nonactive ingredients with defined proportions. The instantaneous analyses were done after precipitation and solid/liquid separation.

TABLE 8
RESULTS OF MINE AND SYNTHETIC
EFFLUENT INSTANTANEOUS ANALYSES

| | | | PRECIPITATING | |
|---|---|---|---|---|
| | | | AGENTS | |
| TEST # | Contaminant | SAMPLE | (active ingredients) | REDUCTION RATE % |
| LAB200316-04 | CHLORIDES | MINE | KH₂PO₄/Ca(OH)₂ | 81% |
| | | EFFLUENT | | |
| LAB200317-02 | CHLORIDES | MINE | C₆H₈O₆/Ca(OH)₂ | 64% |
| | | EFFLUENT | | |
| LAB200317-08 | CHLORIDES | MINE | KH₂PO₄/Ca(OH)₂ | 72% |
| | | EFFLUENT | | |
| LAB200218-01 | CHLORIDES | SYNTHETIC | Na₂HPO₄/Ca(OH)₂ | 89% |
| | | SOLUTION | | |

### EXAMPLE 4: PHOSPHORUS REDUCTION

Tests and analyses to determine the percentage of phosphorus reduction were done with tablets comprising an active ingredient, or a precipitating agent, and nonactive ingredients (see Table 9). The reduction rates were measured with a spectrophotometer.

Table 9 shows results of the treatment of mine effluent with tablets containing the precipitating agent and nonactive ingredients with defined proportions. The instantaneous analyses were done after precipitation and solid/liquid separation.

TABLE 9
RESULTS OF MINE EFFLUENT INSTANTANEOUS ANALYSES

| | | | PRECIPITATING | |
|---|---|---|---|---|
| | | | AGENTS | |
| TEST # | Contaminant | SAMPLE | (active ingredients) | REDUCTION RATE % |
| LAB191204-03 | PHOSPHORUS | MINE | Ca(OH)₂ | 54% |
| | | EFFLUENT | | |
| LAB191204-03-1 | PHOSPHORUS | MINE | Ca(OH)₂ | 95% |
| | | EFFLUENT | | |
| LAB191204-03-2 | PHOSPHORUS | MINE | Ca(OH)₂ | 99.8% |
| | | EFFLUENT | | |

Although the present disclosure has been described using specific embodiments, it is understood that several variations and modifications can be made to said embodiments, and the present disclosure seeks to cover such modifications, uses or adaptations of the present disclosure.

1-217. (canceled)

218. Solid and hydrolysable tablet comprising at least one active ingredient that is a precipitating agent, and at least one non-active ingredient:
said precipitating agent is chosen from a magnesium salt, an ortho-phosphate salt, and a mixture thereof; and
said non-active ingredient is chosen from a binder, a lubricant and a mixture thereof;
to treat water contaminated with contaminants including ammoniacal nitrogen.

219. The tablet according to claim 218, wherein said magnesium salt is chosen from magnesium sulfate, magnesium chloride, magnesium phosphate, magnesium hydroxide, magnesium oxide, organic magnesium salt, and mixtures thereof.

220. The tablet according to claim 218, wherein said precipitating agent comprises a compound chosen from Mg₃(PO₄)₂, MgH(PO)₄.3H₂O, MgSO₄, Na₃PO₄, MgCl₂.6H₂O, Na₂HPO₄, C₄H₄MgO₅, MgO, Citrate Mg, C₆H₆MgO₇, and mixtures thereof.

221. The tablet according to claim 218, said tablet further comprising a calcium salt, a sodium salt of a mixture thereof.

222. The tablet according to claim 221, wherein said calcium salt is chosen from calcium sulfate, calcium chloride, calcium phosphate, calcium hydroxide, calcium oxide and mixtures thereof.

223. The tablet according to claim 221, wherein said sodium salt is chosen from sodium sulfite; sodium thiosulfate; sodium bisulfite; sodium ascorbate; sodium carbonate, and mixtures thereof.

224. The tablet according to claim 218, wherein said precipitating agent is in hydrate form.

225. The tablet according to claim 218, wherein said precipitating agent is in anhydrous form.

226. The tablet according to claim 218, said tablet further comprising an agglomerating agent chosen from polyelectrolytes, polymer, polyacrylamide, a sodium carbonate, sodium bicarbonate, lime, tannin, and mixtures thereof.

227. The tablet according to claim 226, wherein said binding agent is a polyacrylamide.

228. The tablet according to claim 218, wherein the binder is chosen from cellulosic products, fat, oil such as vegetable oil, cocoa butter, coconut butter, starch, lactose, sucrose, gelatin, gum arabic, glucose, sorbitol and mixtures thereof.

229. The tablet according to claim 218, wherein the lubricant is chosen from magnesium stearate, aluminum stearate, talc, silica, fat, oil such as vegetable oil, cocoa butter, coconut butter, and mixtures thereof.

230. The tablet according to claim 218, said tablet comprising about 90% to about 100% by weight of precipitating agent and about 0.1% to about 10% by weight of nonactive ingredient.

231. The tablet according to claim 218, said tablet is compressed from about 100 kilogram-force (Kgf)/cm2 to about 2,000 Kgf/cm2, from about 200 Kgf/cm2 to about 2,000 Kgf/cm2, from about 300 Kgf/cm2 to about 2,000 Kgf/cm2, from about 400 Kgf/cm2 to about 2,000 Kgf/cm2, from about 500 Kgf/cm2 to about 2,000 Kgf/cm2, from about 800 Kgf/cm2 to about 2,000 Kgf/cm2, from about 1,000 Kgf/cm2 to about 2,000 Kgf/cm2, or from about 1,500 Kgf/cm2 to about 2,000 Kgf/cm2.

232. The tablet according to claim 218, comprising:
at least one magnesium salt; and at least one ortho-phosphate salt.

233. A method of manufacturing a tablet as described in claim 218 for treatment of contaminated water, said method comprising:
mixing at least one active ingredient and at least one non-active ingredient in accordance with predetermined weights;
homogenizing the mixture;
compressing the mixture to obtain said tablet; and
controlling parameters of mass, hardness and/or dissolution rate.

234. A process for treating contaminated water, the said process comprising:
contacting contaminated water with a tablet comprising a precipitating agent;
contacting of the contaminated water with an agglomerating agent chosen from polyelectrolytes, polymer, polyacrylamide and mixtures thereof;
dissolving the precipitating agent;
mixing the dissolved precipitating agent with the contaminated water;
precipitation of said contaminant at a pH of 7.5 to 10; and
separation of said contaminant in order to obtain a treated water;
wherein said contaminant comprising ammoniacal nitrogen.

235. Kit comprising at least two tablets:
a first solid and hydrolysable tablet comprising a precipitating agent, wherein the precipitating agent is chosen from a magnesium salt, an ortho-phosphate salt;
and mixtures thereof; and
a second solid and hydrolysable tablet comprising an agglomerating agent, wherein the agglomerating agent is chosen from polyelectrolytes, polymer, polyacrylamide and mixtures thereof.

236. Method of using the tablet according to claim 218, to treat water loaded with a contaminant, wherein the contaminant is ammoniacal nitrogen, said method comprising contacting said tablet with said water loaded with the contaminant.

237. The method of use according to claim 236, wherein said use allows to precipitate said ammoniacal nitrogen in the form of magnesium ammonium phosphate (MAP).
